(19) United States
(12) Patent Application Publication
(10) Pub. No.: US 2026/0171088 A1
(43) Pub. Date: Jun. 18, 2026

(54) METHOD AND APPARATUS FOR ANALYZING SCREEN COMPONENTS FOR VOICE CONTROL OF A DISPLAY INTERFACE

(71) Applicants: HYUNDAI MOTOR COMPANY, Seoul (KR); KIA CORPORATION, Seoul (KR)

(72) Inventor: Jang Sun Lee, Hwaseong-si (KR)

(73) Assignees: HYUNDAI MOTOR COMPANY, Seoul (KR); KIA CORPORATION, Seoul (KR)

(21) Appl. No.: 19/242,788

(22) Filed: Jun. 18, 2025

(30) Foreign Application Priority Data
Dec. 16, 2024 (KR) 10-2024-0186832

(51) Int. Cl. G10L 15/22; G06V 10/70; G06V 20/62; G10L 15/183

(52) U.S. Cl. CPC G10L 15/22; G06V 10/70; G06V 20/62; G10L 15/183; G10L 2015/223

(57) ABSTRACT

A method of analyzing screen components for voice control of a display interface, include recognizing an utterance of a user and determining whether the utterance is included in a name list on a screen. The method also includes executing an operation of a screen component corresponding to the utterance and stored in the name list based on determining that the utterance is included in the name list. The name list stores screen components extracted using a Large Vision-Language Model (LVLM) based on a predetermined screen being recognized and names assigned to the extracted screen components.

### CROSS-REFERENCE TO RELATED APPLICATION

This application claims the benefit of and priority to Korean Patent Application No. 10-2024-0186832, filed on Dec. 16, 2024, the entire contents of which are hereby incorporated herein by reference.

### TECHNICAL FIELD

The present disclosure relates to a method and apparatus for analyzing screen components for voice control of a display interface.

### BACKGROUND

The content described in this section merely provides background information related to the present disclosure and does not constitute prior art.

In general, in order to control a component in an unspecified screen displayed on a display by voice, there is a limitation that the source code constituting the screen needs to be accessed and the type (e.g., whether it is a button type) and text value (e.g., button name) of the component needs to be received from the source code in order to control the component. Therefore, in order for a display system to interact with various applications, the method (e.g., communication protocol) in which each application communicates with the system needs to be adjusted. However, this causes a problem that each application needs to undergo separate development operation to communicate with the display system. In other words, the function of each application needs to be modified or new code needs to be additionally created according to the method required by the display system. In this process, if a developer manually creates code or changes settings, human error may occur. For example, if the text value of a specific icon button is missing or incorrectly named in the code, the button cannot be controlled by voice. Thus, for example, in the case of applications such as 3rd party applications and web screens whose source code is inaccessible, screen components cannot be controlled by voice.

### SUMMARY

In view of the above, embodiments of the present disclosure provide a method and apparatus in which a speech recognition system controls a screen user interface (UI) by voice separately from development code of a screen by analyzing screen components displayed on a display and assigning a name to each component.

The objects to be achieved by the present disclosure are not limited to the objects mentioned above. Other objects that are not mentioned herein should be more clearly understood by those having ordinary skill in the art from the description below.

According to an embodiment of the present disclosure, a method of analyzing screen components for voice control of a display interface is provided. The method includes recognizing an utterance of a user and determining whether the utterance is included in a name list on a screen. The method also includes executing an operation of a screen component corresponding to the utterance and stored in the name list based on determining that the utterance is included in the name list. The name list stores screen components extracted using a Large Vision-Language Model (LVLM) based on a predetermined screen being recognized and names assigned to the extracted screen components.

According to another embodiment of the present disclosure, an apparatus for analyzing screen components for voice control of a display interface is provided. The apparatus includes a memory storing instructions and a processor configured to execute the instructions to recognize an utterance of a user, determine whether the utterance is included in a name list on a screen, and execute an operation of a screen component corresponding to the utterance and stored in the name list based on determining that the utterance is included in the name list. The name list stores screen components extracted using a Large Vision-Language Model (LVLM) on the basis of a predetermined screen being recognized and names assigned to the extracted screen components.

According to embodiments of the present disclosure, a speech recognition system can control a screen interface by voice separately from development code of a screen by analyzing components in the screen displayed on a display and assigning a name to each component.

According to embodiments of the present disclosure, it is possible to control the operation of a screen of a 3rd party application whose code is inaccessible without a “paid content metadata database (DB)”.

The effects of the present disclosure are not limited to the effects mentioned above. Other effects that are not mentioned herein should be more clearly understood by those having ordinary skill in the art from the description below.

### BRIEF DESCRIPTION OF THE DRAWINGS

FIG. 1 is a flowchart illustrating a method of analyzing screen components for voice control of a display interface according to an embodiment of the present disclosure.

FIGS. 2A-C are examples of screens illustrating a process for analyzing screen components for voice control of a display interface according to an embodiment of the present disclosure.

FIG. 3 is a flowchart illustrating an utterance processing method according to an embodiment of the present disclosure.

FIG. 4 shows an example of a screen illustrating the utterance processing process according to an embodiment of the present disclosure.

FIG. 5 is a flowchart illustrating a method of analyzing screen components for voice control of a display interface according to another embodiment of the present disclosure.

FIGS. 6A-C are examples of screens illustrating a process for analyzing screen components for voice control of a display interface according to another embodiment of the present disclosure.

FIG. 7 is a flowchart illustrating an utterance processing method according to another embodiment of the present disclosure.

FIGS. 8A-B are examples of screens illustrating an utterance processing process according to another embodiment of the present disclosure.

FIG. 9 is a block diagram showing a computing system for executing a method of analyzing screen components for voice control of a display interface according to an embodiment of the present disclosure.

### DETAILED DESCRIPTION

In this specification, a speech recognition system is used with the same meaning as a speech recognition apparatus, and thus “speech recognition system” and “speech recognition apparatus” are used interchangeably.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, server, and the like may separately embody or be included with a processor and a memory, such as a non-transitory computer readable media, as part of the apparatus.

In order to control a component of an unspecified screen displayed on a display by voice, there is a problem in that the source code constituting the screen needs to be accessed and the type (e.g., whether the component is a button type) and text value (e.g., button name) of the component needs to be extracted from the source code in order to control the component.

When a user utters “button text name” or “button icon name”, a speech recognition system performs an operation of clicking the coordinates of the corresponding area on the display screen.

Text buttons include, for example, Hyundai Department Store Trade Center, 517 Teheran-ro, Gangnam-gu, Seoul, Set as destination, Add stop, etc.

For example, the name of the icon button [symbol] defined in the source code is “Parking Lot”, and the name of the icon button [symbol] defined in the source code is “Home”.

The coordinate values of each area of the distinguished text and icon are extracted based on the code. For example, the coordinate values of the upper left corner on the display may be represented as “(0px, 0px)”, and the coordinate values of the Hyundai Department Store Trade Center located in Korea on the display may be represented as “(300px, 150px)”.

When the speech recognition system is executed (or before being executed), the source code of the screen displayed on the display is accessed, and text buttons and icon buttons displayed on the screen are listed up by extracting type (whether it is a button type) and text (button name) values from the source code. In addition, the coordinate values of each area of distinguished text and icon are extracted from the source code and the extracted coordinate values are stored.

Embodiments of the present disclosure provide a speech recognition system that controls a screen UI by voice separately from the development code of a screen by analyzing components in the screen displayed on a display using, for example, LVLM, and assigning a name to each component. According to embodiments of the present disclosure, in the case of a 3rd party application whose code is inaccessible, the screen operation of the application can be controlled by voice without securing a “paid content metadata DB” (e.g., a real-time content name list provided by Netflix) of the application company.

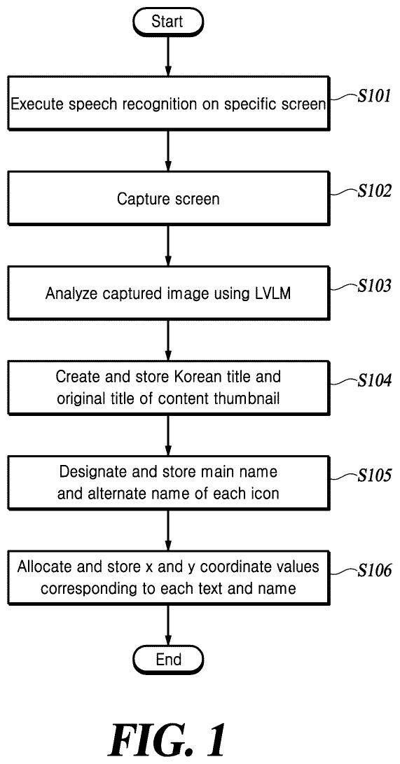

FIGS. 1-4 illustrate a case of a 3rd party application and a web screen in a vehicle head unit system according to embodiments of the present disclosure.

FIG. 1 is a flowchart illustrating a method of analyzing screen components for voice control of a display interface according to an embodiment of the present disclosure.

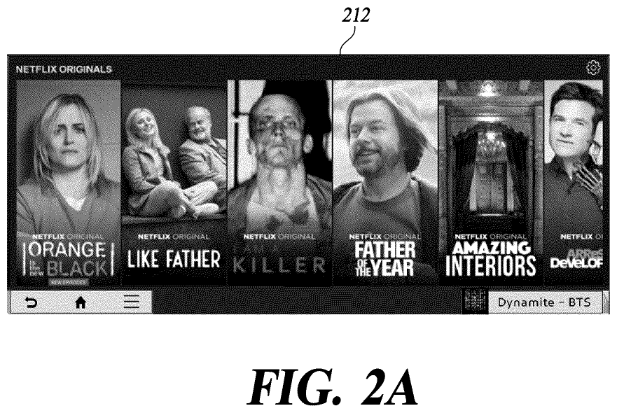

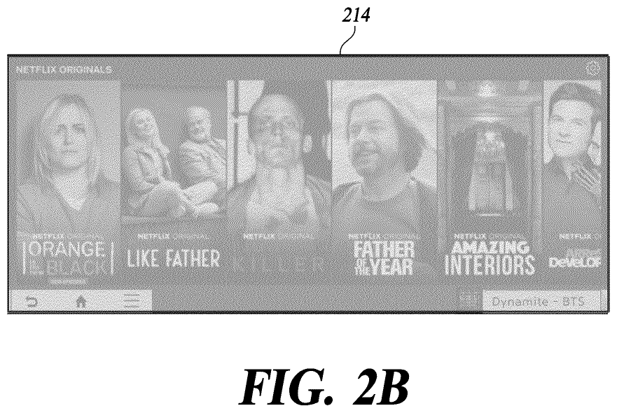

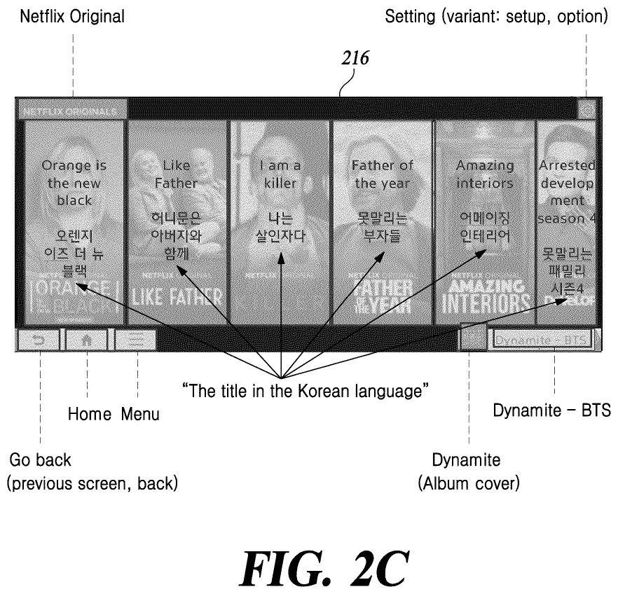

FIGS. 2A-C are examples of screens illustrating a process for analyzing screen components for voice control of a display interface according to an embodiment of the present disclosure.

Hereinafter, a method of analyzing screen components for voice control of a display interface according to an embodiment of the present disclosure is described in more detail with reference to FIG. 1 and FIGS. 2A-C.

In a step or operation 101, a speech recognition execution unit (not shown in the figures) of a speech recognition apparatus executes speech recognition on a specific screen. The speech recognition apparatus executes speech recognition on a screen of a 3rd party video content application (e.g., Netflix application), as indicated by reference numeral 212 in FIG. 2A, for example.

In a step or operation 102, a screen capture unit (not shown in the figures) of the speech recognition apparatus captures a screen displayed on a display. The speech recognition apparatus captures a screen of the 3rd party video content application, as indicated by reference numeral 214 in FIG. 2B, for example.

In a step or operation 103, the speech recognition apparatus analyzes the captured image using the Large Vision-Language Model (LVLM). For example, the speech recognition apparatus lists up the text, icons, and content thumbnail images displayed on the screen by analyzing the captured image using the LVLM. In an embodiment, the screen capture unit of the speech recognition apparatus requests classification of each text/image, search for titles of content thumbnails in the image, assignment of names to icons, and allocation of text/content titles/icon names to the coordinates within each display area when transmitting the captured image to the LVLM.

Examples of prompts used in the aforementioned requests, according to embodiments, are as shown in Table 1 below.

TABLE 1

| | |
|---|---|
| 1. | Please classify and define each text or icon or content thumbnail |
| | image area. |
| 2. | For content thumbnails, please find <Korean version> and |
| | original version of title name of each thumbnail. |
| | For icons, please designate a main name and alternative names of |
| | each icon in <for Korean>. |
| 3. | Please assign each text and name to the corresponding area. |
| | (or) Please assign XY coordinate pixel value of each text and name. |

For reference, the LVLM is an AI system that can simultaneously understand and process text and vision data such as images or videos. In recent AI research, the LVLM has been particularly noted in the field of multimodal AI. The LVLM performs the following operations.

The LVLM may comprehensively understand and analyze text (languages) and image (vision) data. For example, the LVLM may generate an answer by viewing an image provided with a text question or generate text describing the image.

In addition, the LVLM has the ability to connect visual content and linguistic content at a level similar to that of humans by learning a large amount of images and text data together.

The LVLM may (e.g., automatically) generate an explanation after viewing and analyzing a captured image.

The LVLM may provide an answer to a text question related to an image. Results of such automatic explanation generation and an answer to a question can be displayed using a display. Additionally, the LVLM may generate or edit an image based on text input, and analyze, summarize, or describe video data.

In a step or operation 104, the speech recognition apparatus creates (or allocates) and stores the titles in a first language (e.g., Korean titles) and title in a second language (e.g., original titles in English) of content thumbnails on the screen using the LVLM. As indicated by 216 in FIG. 2C, the speech recognition apparatus creates and stores the Korean titles and original titles of the content thumbnails using the LVLM. For example, an original title is created and stored as “Like Father” and a Korean title is created and stored as “ [symbol] [symbol] [symbol] [symbol] [symbol] [symbol] [symbol] [symbol] [symbol] [symbol] ”

In a step or operation 105, the speech recognition apparatus designates (or allocates) and stores a main name and an alternate name of each icon using the LVLM.

As shown in FIG. 2C, in an embodiment, the speech recognition apparatus designates (or allocates) and stores main names and alternate names of the icons using the LVLM.

For example, a main name of an icon is “Go Back” and an alternate name (or variant) of the icon is “Previous screen”, “Back”, or “Return”.

As another example, a main name of an icon is “Setting” and an alternate name (or variant) of the icon is “Setup” or “Option”.

In a step or operation 106, the speech recognition apparatus allocates and stores x and y coordinate values corresponding to each text, name, and icon using the LVLM.

In an embodiment, the coordinates of “setting” (icon) are allocated and stored as (1900px, 20px), and the coordinates of a thumbnail image such as “ [symbol] [symbol] [symbol] [symbol] [symbol] [symbol] [symbol] [symbol] [symbol] [symbol] ” are assigned and stored as (350px, 360px).

Step or operations 104, 105, and 106 do not need to be performed in a specific order, and the order in which each step or operation is performed first may be freely selected. Therefore, the steps or operations are set such that there is no problem in the entire process regardless of which of the three steps is started first, in various embodiments.

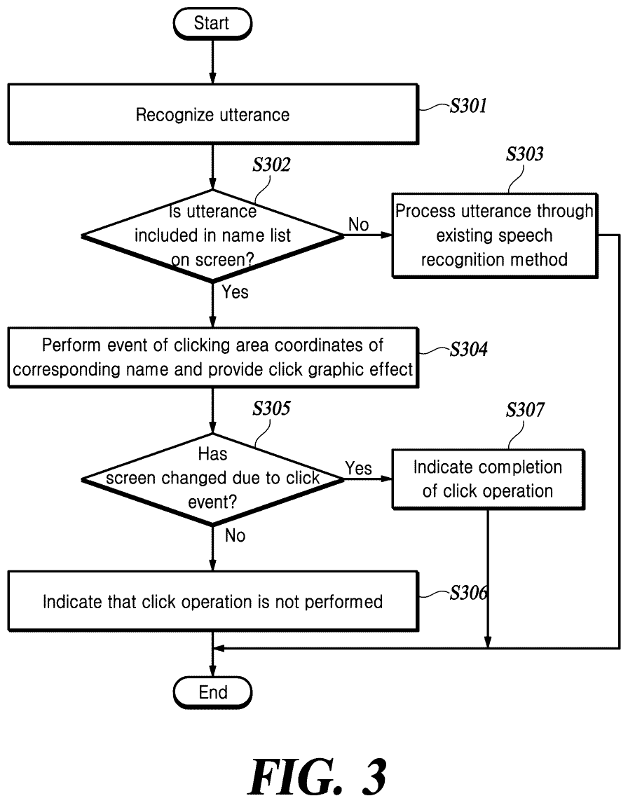

FIG. 3 is a flowchart illustrating an utterance processing method according to an embodiment of the present disclosure.

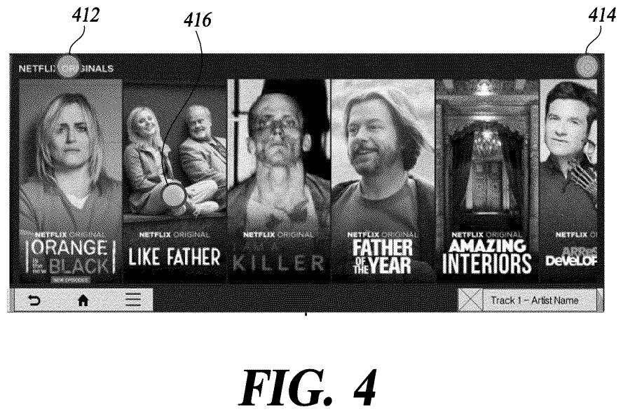

FIG. 4 is an example of a screen showing an utterance processing process according to an embodiment of the present disclosure.

An utterance processing method according to an embodiment of the present disclosure is described in more detail below with reference to FIG. 3 and FIG. 4.

In a step or operation 301, when a user's utterance is input, the speech recognition apparatus recognizes the input utterance and converts the recognized utterance into text. The content of the utterance may be, for example, “(play) Like Father”, “(play) [symbol] [symbol] [symbol] [symbol] [symbol] [symbol] [symbol] [symbol] [symbol] [symbol] ”, “(press) Settings (button)”, “(press) Menu (button)”, or “(press) Netflix Original”

In an embodiment, the converted text is input into a natural language understanding (NLU) intent classifier of the speech recognition apparatus. The NLU intent classifier is a system that analyzes an intent in a sentence input by a user and classifies the intent into one of predefined categories or classes. The NLU intent classifier is mainly used in Chatbots, speech recognition systems, and search engines, and may be implemented using machine learning and deep learning technologies.

In a step or operation 302, the speech recognition apparatus determines whether the input utterance is an utterance in a name list on the screen. The name list on the screen refers to the list listed up in the step or operation 103 in FIG. 1.

If the input utterance is not an utterance in the name list on the screen, the speech recognition apparatus processes the utterance in the existing speech recognition method in a step or operation 303. An input utterance that is not an utterance in the name list on the screen, may be, for example, “Let's go to the xxxx cafe” or “Turn on the air conditioner”.

On the other hand, if the input utterance is an utterance in the name list on the screen, the speech recognition apparatus performs an event of clicking the area coordinates of the corresponding name and provides a click graphic effect in a step or operation 304. Performing an event of clicking the area coordinates of the corresponding name means that, when a user mentions a specific name using speech recognition, the speech recognition apparatus executes an event of clicking the area (coordinate values) where the name is located.

For example, if the input utterance is “(play) Like Father” and the utterance corresponds to a name included in the list, the speech recognition apparatus performs an event of clicking the location (coordinate values) occupied by the Like Father thumbnail image on the screen.

The speech recognition apparatus provides a graphic effect when the click event is executed such that the user can visually confirm the operation. The graphic effect may include, but is not limited to, an animation of a button being pressed, a color changing effect, or a highlight.

Reference numeral 412 in FIG. 4 indicates execution of an event of clicking the area coordinates of the name corresponding to “(press) Netflix Original”.

Reference numeral 414 in FIG. 4 indicates execution of an event of clicking the area coordinates of the name corresponding to “(press) Set (button)”.

Reference numeral 416 in FIG. 4 indicates execution of an event of clicking the area coordinates of the name corresponding to “(play) Like Father”.

In a step or operation 305, the speech recognition apparatus determines whether the screen has changed due to the click event.

The speech recognition apparatus determines whether the screen has changed by comparing the captured screen before click with the captured screen after click.

In a step or operation 302, if the screen has not changed due to the click event, the speech recognition apparatus indicates that the click operation is not executed (e.g., “It seems not a button.”) using the display.

On the other hand, if the screen has changed due to the click event, the speech recognition apparatus indicates completion of the click operation (e.g., O.K or the like) using the display in a step or operation 307.

In summary, the operation according to the embodiment of the present disclosure is performed as shown in Table 2 or Table 3, but the present disclosure is not limited thereto.

TABLE 2
Execute speech recognition → “Play Watcha” → (Enter Watcha
screen) → “(Play) Doctor Who Season 6” → (select target text area
or content thumbnail) → start playing content

TABLE 3
Execute speech recognition → “Play Netflix” → (Enter Netflix screen) →
“(Play) Like Father” or “(Play) [symbol] [symbol] [symbol] [symbol] [symbol] [symbol] [symbol] [symbol] [symbol] [symbol] ” →
(select target content thumbnail area) → start playing content

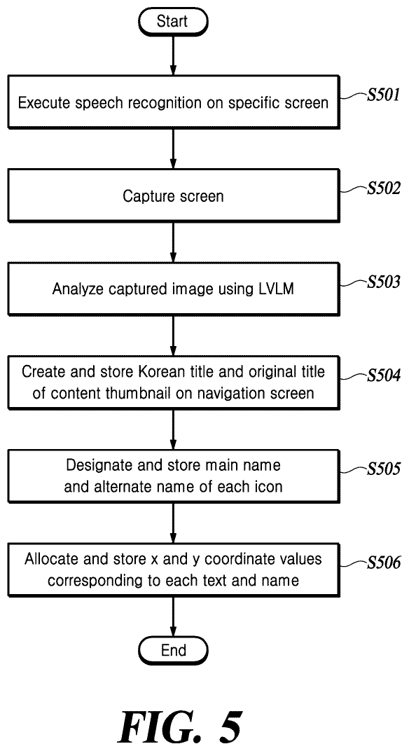

FIGS. 5-8B illustrate a case in which a vehicle head unit system displays a screen of an application thereof, according to an embodiment.

FIG. 5 is a flowchart illustrating a method of analyzing screen components for voice control of a display interface according to an embodiment of the present disclosure.

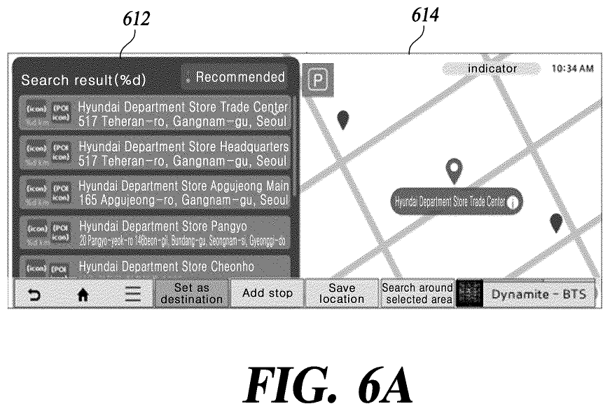

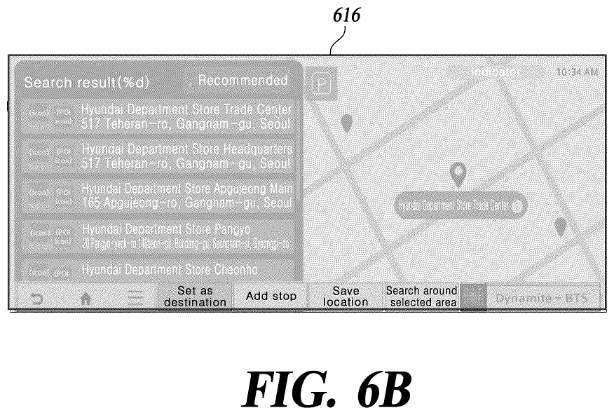

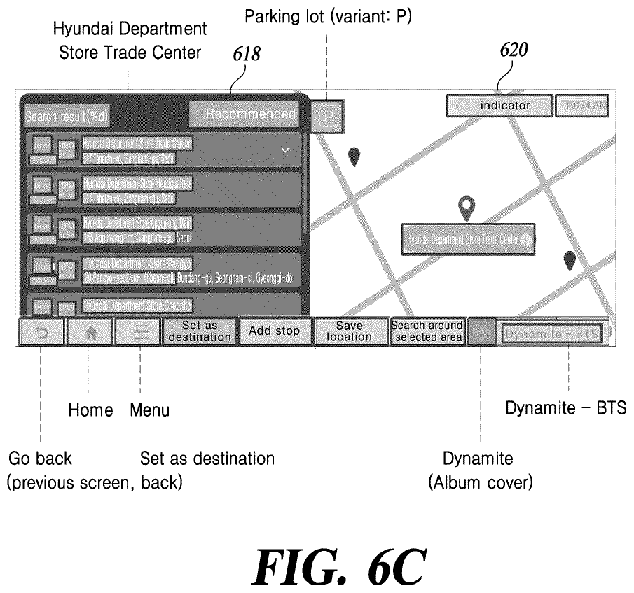

FIGS. 6A-are examples of screens illustrating a process for analyzing screen components for voice control of a display interface according to an embodiment of the present disclosure.

A method of analyzing screen components for voice control of a display interface according to an embodiment of the present disclosure is described in more detail below with reference to FIGS. 5-6C.

In a step or operation 501, a speech recognition execution unit (not shown in the figures) of a speech recognition apparatus executes speech recognition on a specific screen. In an embodiment, the speech recognition apparatus executes speech recognition on its own application screen (e.g., navigation) as illustrated in FIG. 6A.

The speech recognition apparatus performs speech recognition on the navigation (its own application) screen, for example, as indicated by reference numerals 612 and 614 in FIG. 6A.

In a step or operation 502, a screen capture unit (not shown in the figures) of the speech recognition apparatus captures the screen displayed on the display in step 502. The speech recognition apparatus captures the screen of the navigation application, as indicated by reference numeral 616 in FIG. 6B.

In a step or operation 503, the speech recognition apparatus analyzes the captured image using the LVLM. For example, the speech recognition apparatus lists up text and icons displayed on the screen through analysis of the captured image using the LVLM, as indicated by reference numerals 618 and 620 in FIG. 6C. In an embodiment, when the screen capture unit of the speech recognition apparatus transmits the captured image to the LVLM, the screen capture unit requests classification of each text/image, search for titles of content thumbnails in images, assignment of names to icons, and allocation of text/content titles/icon names to coordinates within each display area.

The LVLM may automatically generate an explanation after viewing and analyzing the captured image. The LVLM may provide an answer to a text question related to the image. Results of such automatically generated explanation and the answer to the question may be displayed. Additionally, the LVLM may generate or edit an image on the basis of text input, and analyze and summarize or describe video data.

In a step or operation 504, the speech recognition apparatus creates (or allocates) and stores tiles in a first language (e.g., Korean titles) and titles in a second language (e.g., original titles in English) of content thumbnails in the navigation screen using the LVLM. For example, if content information of the currently playing music on the screen is Dynamite by the BTS, the Korean title is created (or allocated) and stored as “ [symbol] [symbol] [symbol] [symbol] [symbol] [symbol] ” and the original title is created (or allocated) and stored as “Dynamite”.

In a step or operation 505, the speech recognition apparatus designates (or allocates) and stores a main name and an alternative name of each icon using the LVLM.

The speech recognition apparatus designates and stores the main name and alternate name of each icon using the LVLM, as indicated by reference numeral 620 in FIG. 6C. For example, the main name may be “parking lot” and the alternate name may be “P”.

As another example, a main name of an icon may be “Go Back” and an alternate name (or variant) of the icon may be “Previous screen”, “back”, or “return”.

In a step or operation 506, the speech recognition apparatus allocates and stores x and y coordinate values corresponding to each text, name, and icon using the LVLM.

The speech recognition apparatus may allocate and store the coordinates of [symbol] (icon) in FIG. 6C as, for example, (1000px, 50px), using the LVLM.

The speech recognition apparatus may allocate and store the coordinates of [symbol] (icon) in FIG. 6C as, for example, (500px, 700px), using the LVLM.

Steps or operations 504, 505, and 506 do not need to be performed in a specific order, and the order in which each step is performed first can be freely selected. Therefore, the steps are set such that there is no problem in the entire process regardless of which of the three steps is started first, in various embodiments.

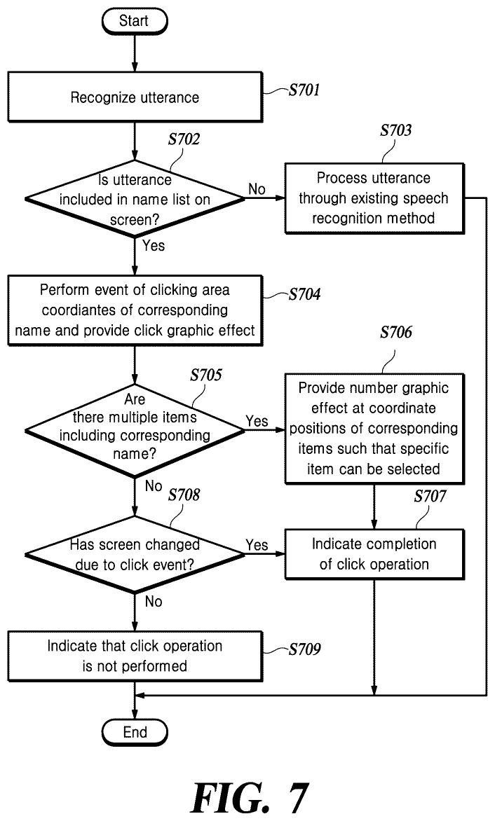

FIG. 7 is a flowchart showing an utterance processing method according to an embodiment of the present disclosure.

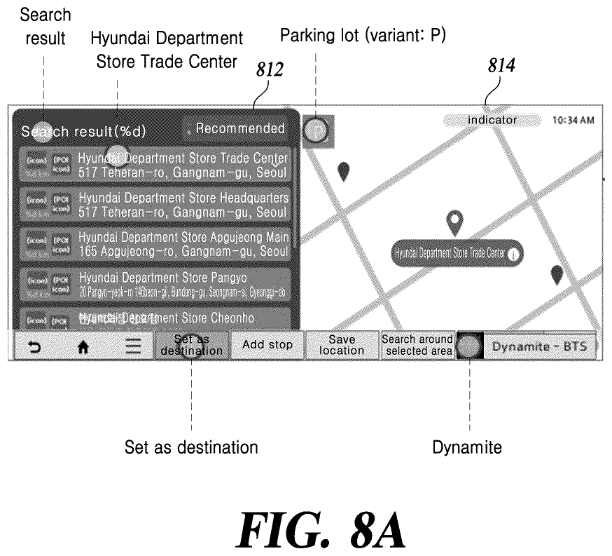

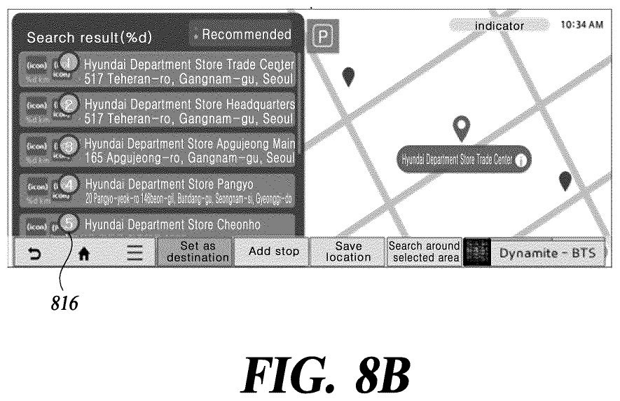

FIG. 8A and FIG. 8B are examples of screens illustrating an utterance processing process according to an embodiment of the present disclosure.

The utterance processing method, according to an embodiment of the present disclosure, is described in more detail below with reference to FIGS. 7-8B.

In a step or operation 701, when a user's utterance is input, the speech recognition apparatus recognizes the input utterance and converts the recognized utterance into text. The content of the utterance may be, for example, “(press) Hyundai Department Store Trade Center”, “(press) Parking Lot (button)”, “(press) Set as destination (button)”, “(press) Dynamite”, “(press) Search result”, or the like.

In an embodiment, the converted text is input into the NLU intent classifier of the speech recognition apparatus. The NLU intent classifier is a system that analyzes an intent in a sentence input by the user and classifies the same into one of categories or classes defined in advance. The NLU intent classifier is mainly used in Chatbots, speech recognition systems, and search engines, and may be implemented using machine learning and deep learning technologies.

In a step or operation 702, the speech recognition apparatus determines whether the input utterance is an utterance in a name list on the screen. The name list on the screen may refer to the list listed in step 503 in FIG. 5.

If the input utterance is not an utterance in the name list on the screen, the speech recognition apparatus processes the utterance in the existing speech recognition method in a step or operation 703. An input utterance that is not an utterance in the name list on the screen, may be, for example, “Let's go to the xxxx café” or “Turn on the air conditioner”.

On the other hand, if the input utterance is an utterance in the name list on the screen, the speech recognition apparatus performs an event of clicking area coordinates of the corresponding name and provides a click graphic effect in a step or operation 704. Screens 812 and 814 of FIG. 8A show that the event of clicking the area coordinates of the corresponding name is performed and the click graphic effect is provided. Performing an event of clicking the area coordinates of a corresponding name means that, when a user mentions a specific name through speech recognition, the speech recognition apparatus executes an event of clicking the area (coordinate values) where the name is located.

For example, if the input utterance is “Hyundai Department Store Trade Center” and the utterance corresponds to a name included in the list, the speech recognition apparatus performs an event of clicking the location (coordinate values) occupied by a Hyundai Department Store Trade Center search result on the screen.

The speech recognition apparatus provides a graphic effect such that the user can visually confirm the operation when the click event is executed. The graphic effect may include, but is not limited to, an animation of a button being pressed, an effect of changing color, or a highlight.

After the step or operation 704, the speech recognition apparatus determines whether there are multiple items including the corresponding name in the search results according to the user's utterance, such as “(press) Hyundai Department Store”, as shown in FIG. 8B.

If there are multiple items including the corresponding name, the speech recognition apparatus provides a number graphic effect at the coordinate positions of the items in step 706 to guide the user to select a specific item. The number graphic effect may be displayed as in \textcircled{1}, \textcircled{2}, \textcircled{3}, \textcircled{4}, and \textcircled{5} in FIG. 8B. The guidance may be, for example, “There are multiple “Hyundai Department Stores”. Which item do you want to select?”

Then, the speech recognition apparatus proceeds to a step or operation 707 and, if a user's utterance “Fifth” or “(press) Hyundai Department Store Cheonho” 816 is recognized in the screen state of FIG. 8B, the speech recognition apparatus indicates the completion of the corresponding click operation (e.g., O.K or the like) through the display.

On the other hand, if there are no multiple items including the corresponding name in a step or operation 705, the speech recognition apparatus proceeds to a step or operation 708 and determines whether the screen has changed due to the click event.

The speech recognition apparatus determines whether the screen has changed by comparing the captured screen before the click with the captured screen after the click.

If the screen has not changed due to the click event, the speech recognition apparatus indicates that the click operation is not performed (e.g., “It seems not a button.”) through the display in a step or operation 709.

On the other hand, if the screen has changed due to the click event, the speech recognition apparatus indicates the completion of the click operation (e.g., O.K or the like) through the display in a step or operation 707.

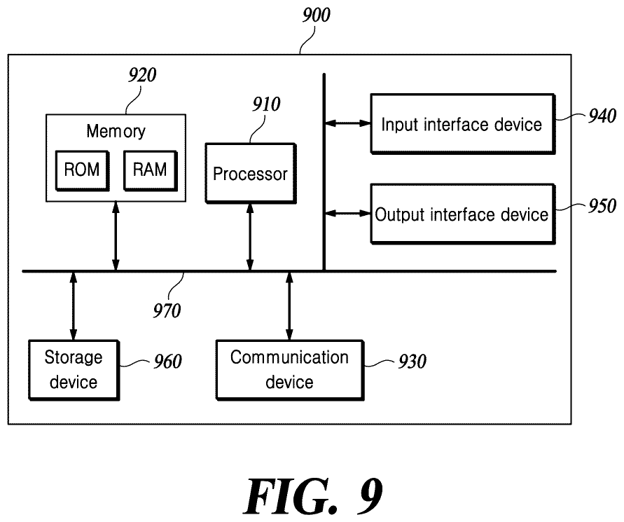

FIG. 9 is a block diagram showing a computing system for executing the method of analyzing screen components for voice control of a display interface according to an embodiment of the present disclosure.

Referring to FIG. 9, the method of analyzing screen components for voice control of a display interface according to an embodiment of the present disclosure described above may implemented through a computing system. The computing system 900 may include at least one processor 910, a memory 920, an input interface device 940, an output interface device 950, a storage device 960, and a communication device 930 which are connected through a system bus 970.

The processor 910 may be a central processing unit (CPU) or a device that executes processing for instructions stored in the memory 920 and/or the storage device 960. The memory 920 and the storage device 960 may include various types of volatile or nonvolatile storage media. For example, the memory 920 may include a read only memory (ROM) and a random access memory (RAM). Accordingly, the steps of methods or algorithms described in relation to the embodiments disclosed herein may be implemented directly in hardware, a software module, or a combination thereof executed by the processor 910. The software module may reside in a storage medium (i.e., the memory 920 and/or the storage device 960), such as a RAM, a flash memory, a ROM, an EPROM, an EEPROM, a register, a hard disk, a removable disk, or a CD-ROM. An example storage medium is coupled to the processor 910 such that the processor 910 may read information from the storage medium and write information to the storage medium. Alternatively, the storage medium may be integrated with the processor 910. The processor and the storage medium may reside in an application-specific integrated circuit (ASIC). The ASIC may reside in a user terminal. Alternatively, the processor and the storage medium may reside as discrete components in a user terminal.

Although the above figures show the processes as being executed sequentially, this is merely an example of the technical idea of one embodiment of the present disclosure. Those having ordinary skill in the art to which the present disclosure pertains may modify and change the order described in the figures without departing from the essential characteristics of one embodiment of the present disclosure or may modify and change one or more of the processes in parallel, and thus the figures are not limited to a chronological order.

The processes illustrated in FIGS. 1, 3, 5, and 7 may be implemented as computer-readable code on a computer-readable recording medium. A computer-readable recording medium includes all types of recording devices that store data that can be read by a computer system. In other words, such a computer-readable recording medium includes non-transitory media such as a ROM, a RAM, a CD-ROM, a magnetic tape, a floppy disc, and optical data storage devices. In addition, the computer-readable recording medium may be distributed over network-connected computer systems such that the computer-readable code can be stored and executed in a distributed manner.

In addition, the components of the present disclosure may use integrated circuit structures such as a memory, a processor, a logic circuit, and a look-up table. These integrated circuit structures execute each function described herein through control of one or more microprocessors or other control devices. In addition, the components of the present disclosure may be specifically implemented by parts of a program or code that includes one or more executable instructions for performing specific logical functions and is executed by one or more microprocessors or other control devices. In addition, the components of the present disclosure may include or be implemented by a central processing unit (CPU), a microprocessor, or the like that performs each function. In addition, the components of the present disclosure may store instructions executed by one or more processors in one or more memories.

What is claimed is:

1. A method of analyzing screen components for voice control of a display interface, comprising:
recognizing an utterance of a user;
determining whether the utterance is included in a name list on a screen; and
executing an operation of a screen component corresponding to the utterance and stored in the name list based on determining that the utterance is included in the name list,
wherein the name list stores screen components extracted using a Large Vision-Language Model (LVLM) based on a predetermined screen being recognized and names assigned to the extracted screen components.

2. The method of claim 1, wherein the screen components include at least one of an icon, a thumbnail image, or text.

3. The method of claim 1, wherein the screen components are extracted by capturing the predetermined screen being recognized and utilizing the LVLM on the captured screen.

4. The method of claim 2, wherein:
the screen components include the icon and the thumbnail image; and
main names and variant names corresponding to the icon and the thumbnail image are assigned and stored in the name list.

5. The method of claim 2, wherein:
the screen components include the text; and
a name in a first language and a name in a second language corresponding to the text are assigned and stored in the name list.

6. The method of claim 2, wherein:
the screen components include the text, the thumbnail image, and the icon; and
coordinate information of the text, the thumbnail image, and the icon is allocated and stored in the name list.

7. The method of claim 4, wherein the name list further includes the main name and the variant name assigned and stored using button type analysis of the icon using the LVLM.

8. The method of claim 4, wherein the name list further includes an original name and a language-specific name of the thumbnail image assigned and stored using the LVLM.

9. The method of claim 1, further comprising:
based on determining that the utterance is included in the name list, determining whether there are at least two items including a name corresponding to the utterance; and
based on determining that there are at least two items, providing a number graphic effect at coordinate positions of the items such that a specific item is selectable.

10. The method of claim 1, wherein recognizing the utterance of the user includes converting speech into text.

11. An apparatus for analyzing screen components for voice control of a display interface, the apparatus comprising:
a memory storing instructions; and
a processor configured to execute the instructions to:
recognize an utterance of a user,
determine whether the utterance is included in a name list on a screen, and
execute an operation of a screen component corresponding to the utterance and stored in the name list based on determining that the utterance is included in the name list,
wherein the name list stores screen components extracted using a Large Vision-Language Model (LVLM) based on a predetermined screen being recognized and names assigned to the extracted screen components.

12. The apparatus of claim 11, wherein the screen components include at least one of an icon, a thumbnail image, or text.

13. The apparatus of claim 11, wherein the screen components are extracted by capturing the predetermined screen being recognized and utilizing the LVLM on the captured screen.

14. The apparatus of claim 12, wherein:
the screen components include the icon and the thumbnail image; and
main names and variant names corresponding to the icon and the thumbnail image are assigned and stored in the name list.

15. The apparatus of claim 12, wherein:
the extracted screen components include the text; and
a name in a first language and a name in a second language corresponding to the text are assigned and stored in the name list.

16. The apparatus of claim 12, wherein:
the extracted screen components include the text, the thumbnail image, and the icon; and
coordinate information of the text, the thumbnail image, and the icon is allocated and stored in the name list.

17. The apparatus of claim 14, wherein the name list further includes the main name and the variant name assigned and stored using button type analysis of the icon using the LVLM.

18. The apparatus of claim 14, wherein the name list further includes an original name and a language-specific name of the thumbnail image assigned and stored using the LVLM.

19. The apparatus of claim 11, wherein the processor is configured to:
based on determining that the utterance is included in the name list, determine whether there are at least two items including a name corresponding to the utterance; and
based on determining that there are at least two items, provide a number graphic effect at coordinate positions of the items such that a specific item is selectable.

20. The apparatus of claim 11, wherein the processor is configured to convert speech corresponding to the utterance into text.
